(19) United States
(12) Patent Application Publication
(10) Pub. No.: US 2010/0252778 A1
(43) Pub. Date: Oct. 7, 2010

(54) NOVEL NANOPARTICLE PHOSPHOR

(75) Inventors: Norio Murase, Osaka (JP); Ping Yang, Osaka (JP); Masanori Ando, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NATIONAL INSTITUTE OF ADVANCED INDUSTRIAL SCIENCE AND TECHNOLOGY, Tokyo (JP)

(21) Appl. No.: 12/675,924

(22) PCT Filed: Jul. 25, 2008
(86) PCT No.: PCT/JP2008/063352

§ 371 Date: Mar. 1, 2010

(30) Foreign Application Priority Data
Aug. 28, 2007 (JP) 2007-220679

(51) Int. Cl. C09K 11/54; B05D 3/02

(52) U.S. Cl. 252/301.6 F; 427/157

(57) ABSTRACT

An object of the present invention is to reduce the incompleteness of the surface state due to lattice constant and steric hindrance, which was heretofore nearly unavoidable, in the surface treatment of light-emitting semiconductor nanoparticles. The present invention provides an excellent luminescent material that has enhanced photoluminescence efficiency, reduced photoluminescence spectrum width, and increased chemical resistance. Specifically, the present invention provides a luminescent material comprising semiconductor nanoparticles having a mean particle size of 2 to 12 nm and a band gap of 3.8 eV or less, each of the semiconductor nanoparticles being coated with a silicon-containing layer, the semiconductor nanoparticles in the luminescent material having a peak emission wavelength 20 nm or more towards the longer-wavelength side than the peak emission wavelength of the semiconductor nanoparticles alone.

### TECHNICAL FIELD

The present invention relates to a luminescent material obtained by coating (deactivating) the surface of semiconductor nanoparticles.

### BACKGROUND ART

Nowadays, luminescent materials are widely used for three applications: illumination, display materials, and various detecting devices, and support our daily lives. Examples of such luminescent materials include organic molecules, as well as fluorescent materials that comprise inorganic matrices in which transition element ions (transition-metal ions and/or rare earth ions) are dispersed. Recently, organic molecules have been increasingly used for electroluminescence, and have also been used as fluorescence reagents in the field of biotechnology.

In the last ten years, it has been discovered that semiconductor nanoparticles obtained by a solution method emit photoluminescence (PL) efficiently; such semiconductor nanoparticles are drawing attention as a third fluorescent material that can be used in place of transition element ions and organic molecules.

Typical examples of such nanoparticles include Group II-VI compounds, such as cadmium selenide, cadmium telluride, zinc selenide, etc.; and plumbous sulfide, lead selenide, indium phosphide belonging to III-V group, and the like are also known. These nanoparticles have a diameter of approximately 2 to 12 nm, and a short emission decay time, and are capable of controlling the emission wavelengths by changing particle diameters. In the present specification, when the particles have an imperfect spherical shape, i.e., a rugby ball shape (spheroid elongated along the symmetry axis direction) or a pancake shape (flattened spheroid), the average of three axis lengths is defined as the diameter.

Such semiconductor nanoparticles have a large specific surface area because of their small particle sizes. In general, semiconductor nanoparticles have many defects (active sites) on their surface, which causes radiationless deactivation. Accordingly, to attain a high PL efficiency, deactivating active sites using a specific method is necessary, particularly when small particles such as nanoparticles are used.

Two general methods of deactivation are known. One method involves coating the surface with another semiconductor having a large band gap, e.g., zinc sulfide; the other method involves binding a sulfur-containing organic surfactant, e.g., thiol, to the surface. The former is typically used for producing cadmium selenide nanoparticles by an organic solution method, and the latter is used for producing cadmium telluride nanoparticles by an aqueous solution method. However, when the surface is coated with another semiconductor, the highest PL efficiency is attained by coating one or two monolayers (average) due to the difference in the lattice constant. (Here, one monolayer indicates one lattice plane spacing perpendicular to the laminating direction.) Further, in the case of an organic surfactant, defects on the surface cannot be wholly covered with thiol molecules due to steric hindrance. Presumably, the perfect deactivation of the surface cannot be achieved since defects on the surface cannot be wholly covered with thiol molecules. In each case, nanoparticles are formed by a solution method; these particles are difficult to handle in their regular state. Accordingly, fixing the particles in a suitable matrix is required for industrial applications.

A theoretical examination (Non-patent Document 1) of the synthesis of nanoparticles in a solution quantitatively reveals that nanoparticles are in equilibrium with a solution therearound, and that the nanoparticles become smaller by permitting constituent atoms to be dissolved into a solution, or grow by taking constituent atoms from therearound. This occurs to varying degrees even when the solution is replaced by a gel-like or solid matrix. In cases where the nanoparticles dissolve or grow over time, the condition of the surface deteriorates to increase defects, which results in a reduction in the PL efficiency.

According to the grain growth theory known as an Ostwald's Law, large nanoparticles become larger, while small nanoparticles dissolve. Nanoparticles of a size between growing particles and dissolving particles show no change in size; accordingly, such nanoparticles have a smooth surface and few defects, which ensures a high PL efficiency (Non-patent Document 2). To maintain the PL efficiency of the obtained nanoparticles, it is important to keep the surface smooth to reduce defects.

Regarding various substances that can serve as a matrix, glass is preferable in view of transparency, chemical resistance, mechanical property, heat resistance, and the like. Accordingly, we conducted studies to disperse nanoparticles in a glass matrix. As a result, we found that the following two points are indispensable in preventing the dissolution and growth of nanoparticles during synthesis, and maintaining the PL efficiency.

1. Since nanoparticles constantly exchange their constituent atoms with a solution or a matrix, a suitable amount of constituent atoms, such as a cadmium ion, is added beforehand to a metal alkoxide, i.e., a starting material of glass, to prevent the dissolution or growth of the nanoparticles.

2. In order to reduce the surface deterioration of nanoparticles, nanoparticles are added after hydrolysis and dehydration condensation proceeds, and the gel solution has a certain viscosity (e.g., 500 mPa/s or more). Thus, the time to solidification is shortened as much as possible.

These techniques enabled us to succeed in retaining nanoparticles in a glass, while keeping the initial PL efficiency. We have also succeeded in producing the following three types of material: plate-like glasses (Patent Document 1 and Non-patent Document 3), thin films (Patent Document 2 and Non-patent Document 4), and small glass beads (Patent Documents 3 and 4, and Non-patent Document 5).

Among the three photoluminescent material applications mentioned in the beginning, semiconductor nanoparticles have been used for various detecting devices, particularly as bio-related fluorescence reagents. In this field, antibodies are attached to the nanoparticles, which are then dissolved in various solutions such as body fluids etc. for use. However, even if the nanoparticles are coated with another substance, the solution permeates through the nanoparticles, which adversely affects the surface, leading to a reduction in the PL efficiency.

Thus, to deactivate the surface, it is necessary to coat the surface of the nanoparticles with a semiconductor having a different lattice constant; however, as explained above, complete deactivation is difficult due to the difference in the lattice constant and steric hindrance. Furthermore, when the thus-deactivated nanoparticles are dispersed in a solution as such, or after being stabilized in a matrix, the dissolution of the surface proceeds, which reduces the PL efficiency. Accordingly, current fluorescent nanoparticles have two major disadvantages (incomplete surface deactivation, and dissolution in solutions).

### [Patent Document 1] Pamphlet of WO2004/000971

### [Patent Document 2] Pamphlet of WO2006/095633

[Patent Document 3] U.S. Pat. No. 3,677,538

### [Patent Document 4] Pamphlet of WO2006/318748

### [Non-patent Document 1] Talapin et al., Journal of Physical Chemistry B, vol. 105, p. 2260, (2001).

### [Non-patent Document 2] Talapin et al., Journal of American Chemical Society, vol. 124, p. 5782, (2002).

### [Non-patent Document 3] Li et al., Langmuir, vol. 20, p. 1, (2004).

### [Non-patent Document 4] Yang et al., Langmuir, vol. 21, p. 8913, (2005).

### [Non-patent Document 5] Yang et al., the 18^{th} Fall Meeting of the Ceramic Society of Japan, 1C05 (Abstract p. 200), September, 2005.

### DISCLOSURE OF THE INVENTION

### Problems to be Solved by the Invention

An object of the present invention is to provide a luminescent material comprising semiconductor nanoparticles, the semiconductor nanoparticles exhibiting a high PL efficiency and being substantially free of deterioration in the PL efficiency, according to a surface-deactivating method that is unaffected by the difference in the lattice constant and steric hindrance of the surface layer; and a method for producing the same.

### Means for Solving the Problems

As a result of extensive research, the present inventors found that a luminescent material that solves the above problem can be obtained by coating semiconductor nanoparticles with a transparent layer (particularly, a glass layer containing silicon), followed by heating. Additionally, the present invention makes it easy to adjust the emission wavelength.

The present inventors also found that when the transparent layer contains a large amount of various metal elements that serve as starting materials for semiconductor nanoparticles, the aforementioned effects become significant. They consider this mechanism as follows.

First, the characteristics of semiconductor nanoparticles are briefly explained.

Semiconductor nanoparticles generally have a size (diameter) of about 2 to about 10 nm. When they contain lead or the like, semiconductor nanoparticles have a size larger than the above, i.e., about 12 nm. FIG. 1 shows the relation between the particle size and the band gap (the energy difference between is orbital of an electron and is orbital of a hole). In the nanoparticle size range, the band gap narrowed with an increase in the particle size. Since the constituent atoms number in the hundreds to thousands in this range, the percentage of atoms on the surface is several tens of percentages.

As explained in the section “Background Art”, such nanoparticles can be synthesized by heating and stirring constituent elements in a solution while promoting grain growth. The band gap of such nanoparticles can be determined from the wavelength in which light absorption occurs. It is preferable that the band gap be 3.8 eV (wavelength of about 326 nm) or lower, since high intensity light, i.e., visible light to infrared light, can be obtained. All of the Group II-VI semiconductors that are generally used in this field have a band gap in this range.

The relation between wavelength λ (nm) and energy E (eV) can be described by the following formula.

$$λ \text{/} nm = \frac{1239.8}{E \text{/} eV} \qquad [ Math . 1 ]$$

In this specification, the PL efficiency of semiconductor nanoparticles is defined as the ratio (Φ_{PL}/Φ_{A}) of the number of photons (Φ_{PL}) emitted as photoluminescence to the number of photons (Φ_{A}) absorbed. The PL efficiency is a value normally used in this technical field, and is synonymous with the term “internal quantum yield”. The material used in the present specification can be singly dispersed in a solution to the extent that scattering can be ignored. Accordingly, the PL efficiency can be measured in a solution state. The PL efficiency is determined by using a dye molecule whose fluorescence PL efficiency is known, and comparing the absorbance and the PL intensity of the dye molecule solution with a measurement target at an excitation light wavelength. During the measurement, the absorbance of the dye molecule solution and the measurement target at the same excitation wavelength are made identical for comparison by a known method (e.g., Dawson, et al., Journal of Physical Chemistry, vol. 72, p. 3251 (1968)). To reduce error, the absorbance of the excitation light wavelength is often set to be about 0.05. As a dye, an aqueous 0.1N sulfuric-acid solution of quinine can be used. When the scattering of powders etc. is considerable, integrating sphere measurement may be used. The method of measurement is disclosed, for example, in Journal of the Illuminating Engineering Institute of Japan, vol. 83, p. 87 (1999)).

In the present invention, the transparent layer is formed around nanoparticles. As a substance for forming the transparent layer, those having a band gap larger than that of semiconductor nanoparticles are advantageous, and those having a band gap of 3.8 eV or more that do not absorb visible light are preferable. Examples thereof include amorphous materials such as glass and high polymers. To avoid swelling etc. in the heating process, a transparent glass layer that contains silicon is more preferably used.

Subsequently, the semiconductor nanoparticles coated with the transparent layer are heated, and the following phenomena are observed: a red-shift of emission wavelength, increased PL efficiency, narrowed emission spectral width, etc. As stated above, a heat-related emission wavelength red-shift is also observed in the known heating treatment. When heating is conducted after coating with a transparent layer, as in the present invention, the dispersion of substances in the transparent layer is smaller than that in a solution, which should delay the grain growth rate. However, the rate of emission red-shift is actually about 100 times faster than that of a general heating and stirring treatment. Further, the degree of increase in the PL efficiency is larger than that of a general heating and refluxing treatment, and no reduction in full-width at half-maximum (FWHM) is observed in a general heating and refluxing treatment. Additionally, the light absorption spectrum shows that absorption in the short wavelength side is increased as stirring proceeds, compared to that of nanoparticles.

Here, assume that semiconductor particles formed of the same molecules are gradually made smaller in size. In this case, the band gap becomes wider, and the wavelength that initiates light absorption shifts to the short wavelength side, compared to a bulk body of a sufficiently large size. As for such small particles, those having a diameter of about 2 to about 10 nm are referred to as nanoparticles, and those having a size between molecules and nanoparticles (a diameter of about 0.2 to about 2 nm) are referred to as clusters (see, for example, Chemical Frontier 7, Nanomaterial Frontier (Kagaku Dojin, (2002), edited by Kazuyuki HIRAO), Chapter 23, Nanoluminescent Material, (Norio MURASE)).

The typical cluster size may be about 1 nm, and the Physical Dictionary (3rd edition, Baifukan, (2005)) defines clusters as an ensemble of aggregation of atoms or molecules. The heat-related growth of such semiconductor clusters is considered to cause an absorption increase in the short wavelength side, as observed in the present specification. The lower size limit of the semiconductor clusters depends on the size of the molecule. Since the compound semiconductor used herein contains a heavy atom such as cadmium or tellurium, the lower size limit is about 0.5 nm.

Possible mechanisms of the heat-related emission wavelength red-shift, increase in PL efficiency, and like phenomena are explained below using a schematic view.

When a bulk semiconductor (sufficiently large size) that has a band gap corresponding to a wavelength in the red to infrared region is made into nanoparticles of a small particle size, the nanoparticles emit green PL due to the quantum size effect, as shown in FIG. 1. The nanoparticles also emit green PL when coated with a transparent layer (FIG. 2, left side). However, when heated, the emission wavelength shifts to the red side, as shown in the right side of FIG. 2. It is considered that clusters grow in the transparent layer during heating.

Excitons are formed when a semiconductor absorbs light. An exciton is composed of an electron and a hole. When a nanoparticle is present in the vicinity of clusters, electrons are distributed while moving between the nanoparticle and clusters due to the tunneling effect. Presumably, such a distribution of electrons provides the same effect as when the particle size is enlarged, which narrows the band gap and causes red-shift. In addition, the distribution range of electrons becomes wider as the clusters become larger, which causes a further red-shift. Apparently, the heat-related red-shift of emission wavelength reflects the process of such cluster growth.

The surface of nanoparticles is uneven for various reasons. If the layers of other atoms are directly attached to the surface for deactivation, the degree of unevenness tends to increase due to the mismatch of the lattice constant etc. In contrast, it is considered that when the nanoparticle is coated with clusters at a certain distance, the condition of the surface becomes uniform, which decreases the FWHM, resulting in an increase in the PL efficiency.

Further, the semiconductor nanoparticles are not easily soluble because they are coated with a transparent layer in which various elements are dispersed. In particular, when a silicon-containing matrix is used, the network structure relatively develops by heating; therefore, nanoparticles are not likely to deteriorate even if introduced in an aqueous solution in which a large amount of ions are dispersed.

These advantages were confirmed, and the present invention was accomplished.

The present invention provides the following luminescent material that contains semiconductor nanoparticles, and method for producing the same.

### Item 1

A luminescent material comprising semiconductor nanoparticles having a mean particle size of 2 to 12 nm and a band gap of 3.8 eV or less, each of the semiconductor nanoparticles being coated with a silicon-containing layer, the semiconductor nanoparticles in the luminescent material having a peak emission wavelength 20 nm or more towards the longer-wavelength side than the peak emission wavelength of the semiconductor nanoparticles alone.

### Item 2

The luminescent material according to Item 1, wherein the silicon-containing layer comprises clusters at a concentration of 0.01 mol/L or more, the clusters having a diameter of 0.5 to 2 nm and containing component(s) used for forming the semiconductor nanoparticles.

### Item 3

The luminescent material according to Item 1 or 2, wherein the semiconductor nanoparticles in the luminescent material have an emission spectrum width (full-width at half-maximum, FWHM) at least 10% narrower than the emission spectrum width (FWHM) of the semiconductor nanoparticles alone.

### Item 4

The luminescent material according to Item 1 or 2, wherein the relation between the PL efficiency (id from the semiconductor nanoparticles in the luminescent material and the PL efficiency (η₂) of photoluminescence from the semiconductor nanoparticles alone is η₁≧1.3×η₂.

### Item 5

The luminescent material according to Item 1 or 2, wherein the silicon-containing layer is a glass layer obtained by forming a coating layer on the surface of the semiconductor nanoparticles by a sol-gel method using a silicon alkoxide, and heating the obtained semiconductor nanoparticle coated with the coating layer.

### Item 6

The luminescent material according to Item 1 or 2, wherein the silicon-containing layer is a layer obtained by adding a silicon alokoxide to a semiconductor nanoparticle dispersion, forming a coating layer on the surface of the semiconductor nanoparticles by a sol-gel method, and heating the obtained semiconductor nanoparticle coated with the coating layer.

### Item 7

The luminescent material according to any one of Items 1 to 6, wherein the PL efficiency is 20% or more.

### Item 8

The luminescent material according to any one of Items 1 to 7, wherein the PL efficiency is 70% or more.

### Item 9

The luminescent material according to any one of Items 1 to 8, wherein the semiconductor nanoparticles belong to Group II-VI semiconductors.

### Item 10

The luminescent material according to any one of Items 1 to 8, wherein the semiconductor nanoparticles belong to Group III-V semiconductors.

### Item 11

The luminescent material according to any one of Items 1 to 8, wherein the semiconductor nanoparticles comprise at least one member selected from the group consisting of zinc, cadmium, mercury, sulfur, selenium, tellurium, aluminium, gallium, indium, phosphorus, arsenic, antimony, and lead.

### Item 12

A glass sphere having a diameter of 20 nm to 2 μm, comprising at least two luminescent materials according to any one of Items 1 to 11.

### Item 13

A light-emitting device comprising a luminescent material according to any one of Items 1 to 11.

### Item 14

A fluorescent material for biotechnology applications comprising a luminescent material according to any one of Items 1 to 11.

### Item 15

A method for producing a luminescent material comprising semiconductor nanoparticles each coated with a silicon-containing layer, the method comprising the steps of:

(1) forming a coating layer on the semiconductor nanoparticles having a mean particle size of 2 to 12 nm, and a band gap of 3.8 eV or less, by a sol-gel method using a silicon alkoxide; and

(2) heating the semiconductor nanoparticles on which the coating layer has been formed.

### EFFECT OF THE INVENTION

The luminescent material of the present invention is obtained by coating semiconductor nanoparticles with a transparent glass layer to deactivate the surface, followed by heating. Therefore, compared to luminescent materials that do not undergo heating, the luminescent material of the present invention has a high PL efficiency, narrow emission spectrum width, and high chemical resistance; accordingly, it is more applicable in practical use. In addition, the present invention makes it possible to shift an emission spectrum to the red side without depending on a conventional method, i.e., a method changing the particle size of semiconductor nanoparticles.

The present invention is described in detail below.

### I. Luminescent Material

The luminescent material of the present invention comprises, as a core, semiconductor nanoparticles having a mean particle size of 2 to 12 nm and a band gap of 3.8 eV or less. The surface of each of the semiconductor nanoparticles is coated with a transparent layer (specifically, a glass layer containing silicon).

### Production of Semiconductor Nanoparticles

As the semiconductor nanoparticles of the present invention, fluorescent semiconductor nanoparticles with water dispersibility are preferably used. Specifically mentioned are semiconductor nanoparticles belonging to the Group II-VI or III-V compound semiconductor that undergo direct transition and emit PL in the visible range. Examples thereof include those having at least one element selected from the group consisting of zinc, cadmium, mercury, sulfur, selenium, tellurium, aluminium, gallium, indium, phosphorus, arsenic, antimony, and lead. Specific examples include cadmium sulfide, zinc selenide, cadmium selenide, zinc telluride, and cadmium telluride; of these, cadmium telluride and zinc selenide are preferable. Other examples include lead sulfide, lead selenide, and indium phosphorus, gallium arsenide, and mixtures thereof that belong to the III-V group. Zinc selenide or cadmium telluride is preferable.

All of these semiconductors have a band gap of less than 3.8 eV at room temperature.

The semiconductor nanoparticles can be produced according to Li et al., Chemistry Letters, vol. 34, p. 92, (2005).

More specifically, one or more Group-VI element compounds are introduced into an alkaline aqueous solution under an inert atmosphere in which a water-soluble compound containing a Group-II element and a surfactant are dissolved, thereby obtaining Group II-VI semiconductors. A Group-VI element compound can also be used in the form of a gas.

Preferable as a water-soluble compound containing a Group II element is perchlorate. For example, cadmium perchlorate can be used when the Group II element is cadmium. The concentration of the water-soluble compound containing a Group II element in an aqueous solution is usually within the range of about 0.001 to about 0.05 mol/L, preferably about 0.01 to about 0.02 mol/L, most preferably about 0.013 to about 0.018 mol/L.

Surfactants comprising a thiol group, which is a hydrophobic group, and a hydrophilic group are preferable. Usable as hydrophilic groups are anionic groups such as carboxyl group and the like, cationic groups such as amino group and the like, hydroxyl groups and the like; of these, anionic groups such as carboxyl group and the like are particularly preferable. Specific examples of the surfactant include thioglycolic acid (TGA), thioglycerol, mercaptoethylamine, and the like. The amount of the surfactant is generally about 1 to about 2.5 mols, preferably about 1 to about 1.5 mols, per mol of Group II element ions contained in an aqueous solution. When the amount of surfactant is more than or less than the above-mentioned ranges, the PL efficiency of the nanoparticles obtained tends to decrease.

As a Group VI element compound, Group VI element hydrides and the like are usable, and hydrogen telluride can be used when the Group VI element is tellurium. Hydrogen telluride can also be allowed to react with sodium hydroxide to yield sodium hydrogen telluride, which can be introduced in an aqueous solution state for use. The Group VI element compound is used in such a manner that the amount of Group VI ions is generally about 0.3 to about 1.5 mols, preferably about 0.4 to about 0.9 mols, per mol of Group II ions.

It is preferable to use high-purity water for producing semiconductor nanoparticles. In particular, it is preferable to use ultra-pure water in which the specific resistance is 18 MΩ·cm or more and the total amount of organic compound (TOC) in the water is 5 ppb or less, more preferably 3 ppb or less. A reaction container is sufficiently washed using such high-purity water, and the high-purity water is used as a reaction solvent, thereby obtaining semiconductor nanoparticles with excellent luminescent performance.

As usual, the above-described reaction can be carried out by bubbling, under an inert atmosphere, a gaseous Group VI element compound in an aqueous solution in which a water-soluble compound containing a Group II element and a surfactant are dissolved, or by allowing a gaseous Group VI compound to react with a sodium-hydroxide solution to yield an aqueous solution, and injecting it using a syringe or the like into an aqueous solution in which a water-soluble compound containing a Group II element and a surfactant are dissolved.

There is no limitation to the inert gas, insofar as the gas does not affect the reaction. Preferable examples of the inert gas include argon gas, nitrogen gas, helium gas, and the like.

The above-described reaction can usually be performed at room temperature (for example, about 10° C. to about 30° C.). The pH of the aqueous solution is preferably about 10 to about 12, and more preferably 10.5 to 11.5. The reaction is usually completed within about 10 minutes after the introduction of the Group VI compound.

Thereafter, by refluxing the reaction mixture in atmosphere, an aqueous solution is obtained in which semiconductor nanoparticles of the desired size are dispersed.

The mean particle size of the semiconductor nanoparticles obtained is generally in the range of about 2 to about 12 nm, preferably about 2 to about 8 nm, and most preferably about 3 to about 7 nm. The particle size can be adjusted according to the reflux time. In order to obtain nanoparticles that emit monochromatic light, the reflux time should be kept constant, and the synthesis process should be adjusted so that the standard deviation of the size distribution is 20% or less of the mean particle size.

In order to obtain nanoparticles that emit monochromatic light, the reflux time should be kept constant and the synthesis process should be adjusted so that the standard deviation of the size distribution is 20% or less of the mean particle size, preferably 15% or less.

When cadmium telluride or zinc selenide is used, the particle size is about 2 to about 5 nm. The particle size can be enlarged by increasing the reflux time. The particle size determines the PL color emitted from the semiconductor nanoparticles, and particles with smaller sizes emit shorter wavelengths of light. When the particle diameters of semiconductor nanoparticles are made uniform, monochromatic light can be obtained.

The thus-obtained aqueous solution (aqueous dispersion) of semiconductor nanoparticles usually contains a Group II element ion used as a starting material, a surfactant, etc. By using this aqueous solution of semiconductor nanoparticles, the semiconductor nanoparticles can be dispersed as is in an organic matrix and dried to thereby yield a fluorescent material (phosphor).

The nanoparticles contained in the aqueous solution can be separated according to their particle size. For example, utilizing the fact that larger nanoparticles have lower solubility, the nanoparticles are precipitated in order of size from biggest by adding as poor solvents alcohols such as isopropanol or ketones such as acetone in the aqueous solution of the nanoparticles; thereafter, the results are centrifuged for separation.

When the thus-refined nanoparticles are redispersed in water to yield an aqueous solution, the refined nanoparticles are imparted with a high PL efficiency. The aqueous solution as such is stable to some extent. However, the addition of a water-soluble compound containing a Group II element and a surfactant can improve the stability of the aqueous solution, thereby preventing the aggregation of particles, and maintaining a favorable PL efficiency. The type of Group II element compound, the concentration of the compound, the amount of the surfactant, the pH of the aqueous solution and the like may be adjusted in the same ranges as those of the aqueous solution used for producing the Group II-VI semiconductor nanoparticles described above.

Specifically, an aqueous solution with a pH ranging from about 10 to about 12, preferably about 10.5 to about 11.5, is suitable. More specifically, the aqueous solution comprises Group II-VI semiconductor nanoparticles (about 1×10⁻⁷ to about 3×10⁻⁶ mol/L, preferably about 3×10⁻⁷ to about 2×10⁻⁶ mol/L), a water-soluble compound containing a Group II element as a starting material for the Group II-VI semiconductor nanoparticles (Group II element ion) (about 0.001 to about 0.05 mol/L, preferably about 0.01 to about 0.02 mol/L, and most preferably about 0.013 to about 0.018 mol/L), and a surfactant (about 0.5 to about 5 mols, preferably about 1 to about 1.5 mols, per mol of the Group II element ions contained in the aqueous solution).

In addition, semiconductor nanoparticles of cadmium selenide and the like can be produced in an organic solvent utilizing thermal decomposition of an organic metal. When the surfaces of the semiconductor nanoparticles are replaced with a thiol-containing surfactant, such as TGA and the like, the result is imparted with water dispersibility, and thus can be used as an aqueous solution of semiconductor nanoparticles. This is a known method described in Japanese Unexamined Patent Publication No. 2002-525394, Bawendi et al.

When zinc selenide nanoparticles are used, the PL efficiency is increased to about 35% by ultraviolet irradiation after production using TGA and the like as a surfactant according to the above method. Specifically, production is performed according to the method described in Li et al., Colloids and Surfaces A, vol. 294, p. 33, (2007). In addition, indium phosphorus, gallium arsenide, and the like belonging to the III-V group are also usable.

### Coating of Semiconductor Nanoparticles

Next, the coating layer is applied on the surface of semiconductor nanoparticles by a sol-gel method using a metal alkoxide. Specifically, the use of silicon alkoxide forms a transparent glass layer that contains silicon.

According to one embodiment of the method, a metal alkoxide is added to semiconductor nanoparticles that have been dispersed in water, and the result is alkalified and then stirred. Thereby, the hydrolyzed metal alkoxide is attached to the surface of the semiconductor nanoparticles to coat the surface, yielding glass-coated semiconductor nanoparticles.

In the method, the aqueous dispersion of semiconductor nanoparticles obtained above can be used as is, or a dispersion obtained by isolating produced semiconductor nanoparticles and re-dispersing the result in water can be used.

When the constituent elements of semiconductor nanoparticles are dispersed in a semiconductor nanoparticle dispersion, as explained above, they are naturally taken into a glass layer.

Specifically, the semiconductor nanoparticle dispersion preferably contains semiconductor nanoparticles, a compound containing a metal element other than silicon (e.g., a water-soluble compound containing a Group II or III element, particularly, cadmium perchlorate etc.), a surfactant (e.g., TGA, thioglycerol, etc.), a Group VI or V element compound (e.g., sodium sulfide and sodium telluride), and water. However, when a surfactant contains a Group VI or V element, a Group VI or V element compound is not necessarily added to the dispersion. A metal alkoxide (particularly silicon) is added to this semiconductor nanoparticle dispersion, thereby glass-coating the surface of semiconductor nanoparticles using a sol-gel method.

Thereafter, the aqueous solution that contains glass-coated semiconductor nanoparticles may be heated. Apparently, this allows the components of the aqueous solution to be reacted in the glass layer, thereby forming clusters that contain components for forming semiconductor nanoparticles.

Alternatively, it is also possible to form clusters that contain elements different from those of semiconductor nanoparticles in a glass layer, following the same process as above, by using a semiconductor nanoparticle dispersion that contains elements different from the constituent elements of semiconductor nanoparticles.

Preferable as a metal alkoxide is silicon alkoxide, and preferable as the silicon alkoxide is a tetrafunctional silicon alkoxide such as tetramethoxy orthosilicate, tetraethoxy orthosilicate, etc. Such a silicon alkoxide is represented by General Formula (I):

Si(OR¹)₄ (I),

wherein R¹ is a lower alkyl group.

In addition to the compound represented by General Formula (I) above, it is also possible to use trifunctional silicon alkoxide having an organic functional group such as mercapto propyltrimethoxysilane, aminopropyltriethoxysilane, etc.; or to partially add the trifunctional alkoxide to tertfunctional alkoxide. Here, the trifunctional silicon alkoxide is a compound represented by General Formula (II):

Rₚ³—Si(OR⁴)₄₋ₚ (II),

wherein R³ represent a lower alkyl group having an amino group, thiol group, or carboxy group, R⁴ represents a lower alkyl group, and p is 1, 2, or 3.

In the compound represented by General Formula (II), an organic functional group represented by R³ and an alkoxy group represented by OR⁴ are both combined with an Si atom. Among alkoxides, the compound is particularly referred to as a silane coupling agent.

In order to alkalify the solution, ammonia and sodium hydrate may be used. Ammonia is particularly preferably used.

### Heat Treatment

The luminescent material of the present invention is obtained by heating the semiconductor nanoparticles coated with a glass layer. Preferably, heating is performed in an aqueous solution in which glass-coated semiconductor nanoparticles are dispersed. More preferably, heating is performed in an aqueous solution that contains glass-coated semiconductor nanoparticles, a compound containing a metal element other than silicon (e.g., water-soluble compound containing a Group II or III element, particularly, cadmium perchlorate etc.), a surfactant (e.g., TGA, thioglycerol, etc.), a Group VI or V element compound (e.g., sodium sulfide and sodium telluride), and water. However, when a surfactant contains a Group VI or V element, a Group VI or V element is not necessarily added to the dispersion. Typically, heating is conducted after the nanoparticles are glass-coated according to a sol-gel method using the semiconductor nanoparticle dispersion immediately after production.

This heating makes the glass layer harder, and allows in the glass layer the formation of clusters that contain components for semiconductor nanoparticles, thereby yielding a luminescent material. The clusters generally have a diameter in the range of 0.5 to 2 nm.

Examples of water-soluble compounds that contain a Group II element include those containing a metal as a starting material for semiconductor nanoparticles; specifically, compounds that contain zinc, cadmium, mercury, or like metal are usable. Examples of water-soluble compounds that contain a Group III element include those containing aluminium, gallium, indium, or like metal. Other than the above, compounds may contain lead or copper. These compounds are dissolved in water and are present in an aqueous solution state, while the aforementioned Group II or III elements (metals) are dispersed in a solution in an ion state.

The concentration of the semiconductor nanoparticles in an aqueous solution under heating is not limited, and is usually in the range of 5×10⁻⁷ mol/L to 5×10⁻⁵ mol/L, preferably 2×10⁻⁶ mol/L to 2×10⁻⁵ mol/L. The concentration of semiconductor nanoparticles can be determined by comparing the absorption spectrum of nanoparticles with a reference value (regarding Group II-IV nanoparticles, see William Yu et al., Chemistry of Materials, vol. 15, p. 2854, 2003; and Murase et al., Nanoscale Research Letters, vol. 2, p. 230, 2007).

To attain the effects of the present specification, the relative concentration of metals other than silicon in the aqueous solution must be set in a certain range, relative to the semiconductor nanoparticles. When the mol concentration of semiconductor nanoparticles is 1, the ratio of the mol concentration (molar ratio) of metals other than silicon is preferably 7 to 700, more preferably 20 to 350, and even more preferably 50 to 100. Further, as a substance that provides an anion bonding to a metal, a surfactant such as thiol, or a compound containing phosphorus may be selected. The mol ratio of the surfactant to metals other than silicon is preferably 1 to 15, more preferably 2 to 10, and even more preferably 4 to 6.

At this stage, the glass network structure of the glass layer is not sufficiently developed; heating facilitates the movement of dispersed materials in the glass. The heating temperature may be usually about 50 to about 110° C., preferably 70 to 110° C., and more preferably 80 to 90° C. By refluxing the aqueous solution at a temperature slightly lower than the boiling point, the excessive vaporization of a component such as ammonia can be prevented in an effective manner.

For example, heating may be conducted for about 5 minutes to about 3 hours at 90 to 100° C. According to this treatment, clusters grow in the glass layer. To precisely control the color tone of semiconductor nanoparticles, heating may be performed for 3 hours to 20 hours at a low temperature (50 to 60° C.). To diffuse the dispersed materials in the glass while appropriately advancing the formation of the glass network structure, setting the reaction temperature in a suitable range, as described in the present specification, is effective.

During heating, a novel metal alkoxide is attached to the surface of the glass layer, which often causes a slight increase in glass layer thickness. The wavelength of emission light shifts to the red side as time passes; while monitoring this change, heating is continued until the desired wavelength can be obtained. This promotes the hydrolysis and the dehydration condensation reaction of alkoxide, leading to the development of a glass network structure. Thereby, the nanoparticles can form an excellent luminescent material having high deterioration resistance, as well as a higher PL efficiency and a narrower spectrum width.

In an exciton (a hole and an electron) formed when semiconductor nanoparticles absorb light, the effective mass of the hole is generally several times larger than that of the electron. Therefore, when clusters are present in the vicinity of semiconductor nanoparticles, the electronic distribution width grows due to the electron tunneling effect. This may be a cause of the phenomenon observed.

A glass matrix serves as a reaction field that inhibits free movement of semiconductor nanoparticles and clusters, and promotes the growth of the clusters. Since the clusters do not form a chemical bond with the semiconductor nanoparticles, no mismatch in the lattice constant occurs, which results in a uniform coating of the surface. As a result, the PL efficiency is increased to decrease the spectral width. Moreover, the semiconductor nanoparticles do not deteriorate to a great extent in a solution because they are protected by the clusters therearound.

Clusters have a size smaller than that of semiconductor nanoparticles, i.e., a diameter of 0.5 to 2.0 nm. The diameter is desirably in the range of 0.7 to 1.5 nm, and most desirably in the range of 0.8 to 1.3 nm. To obtain the effects of the invention by dispersing clusters in the glass layer, the concentration of the clusters in the glass layer is preferably 0.01 mol/L or more, more preferably in the range of 0.03 to 4 mol/L, and most preferably in the range of 0.1 to 1 mol/L.

The thickness of the glass layer for the luminescent material of the present invention is generally 0.3 to 5 nm, preferably 0.4 to 3 nm, and most preferably 0.5 to 2 nm.

Conventionally, studies regarding deactivation of semiconductor nanoparticles have focused on how to combine other substances with a surface. However, as described above, the present invention aims to provide a novel surface deactivation method, which is different from the conventional one.

The luminescent material of the present invention can take any desired shape, such as a sphere, plate, or thin film. When the luminescent material has a spherical shape, the mean particle size is 3.5 to 20 nm, and particularly 4 to 7 nm. The luminescent material of the present invention may be used as a fluorescent material for biotechnology applications by putting at least two luminescent materials in a glass sphere 20 nm to 2 microns in size.

The PL spectrum width (FWHM) of semiconductor nanoparticles in the luminescent material of the present invention is at least 10%, and particularly, at least 15% narrower than the PL spectrum width (FWHM) of semiconductor nanoparticles alone. The PL efficiency (η₂) of semiconductor nanoparticles in the luminescent material is generally 20% or more, preferably 50% or more, and most preferably 70% or more. This value is at least 30%, and particularly, at least 50% higher than the PL efficiency (η₁) of semiconductor nanoparticles alone. In equation terms; η₂≧1.3×η₂, particularly, η₂≧1.5×η₁.

Here, the PL spectrum of nanoparticles alone indicates the PL spectrum obtained after the removal of glass coat. In the present specification, the glass coat is removed by dissolving in a strong alkaline solution, after which the PL spectrum is measured. It is confirmed that the PL spectrum obtained here is nearly the same as that obtained before glass coating. This PL is called band-edge emission, and the emission wavelength shows a photon energy value similar to that of band gap energy. The emission decay time is typically about 10 to about 50 nanoseconds.

In contrast, when the semiconductor nanoparticles are dispersed in a glass using a sol-gel method according to a known technique, the PL intensity is often remarkably decreased. When the nanoparticles are dissolved, the emission wavelength shifts to the blue side; when a defect level occurs, the emission wavelength shifts to the red side. In each case, the emission wavelength does not return to its original state even after the removal of glass. The light emitted from a defect level may have a wide spectral width, and the emission decay time may be longer than 100 nanoseconds.

In the method of the present invention, clusters grow in a glass layer by heating; however, it is also possible to add grown clusters into a transparent polymer layer beforehand, and then introduce a desired semiconductor nanoparticle therein.

The luminescent material of the present invention does not necessarily take a small isolated spherical shape. For example, semiconductor nanoparticles may be dispersed in an agglomerate of a transparent layer that is visible to the naked eye, or dispersed in a transparent layer that is formed as a thin film on a substrate.

Since clusters are small in size and coated with a matrix, they are hard to observe directly using a transmission electron microscope (TEM). However, when a sample that is obtained by heating in the same manner as above under no semiconductor nanoparticle conditions is observed using a dark-field scanning transmission electron microscope (ADF-STEM), clusters are detected as bright white spots in the matrix, enabling size estimation. Further, the absorption spectrum that shows an increase in components in the short wavelength side (about 400 nm or less) confirms the presence of clusters. The existence of clusters is also observed as an increase in scattering intensity in the 2θ range of about 3 to about 10° measured by small angle X-ray scattering.

The heating of silica-coated nanoparticles explained herein is one of the processes for forming the luminescent material of the present specification. Heretofore, heating has been conducted for the purpose of advancing the hydrolysis of a functional group-containing alkoxide to thereby coat nanoparticles (see, for example, Shimamoto et al., Journal of American Chemical Society, vol. 125, p. 316, (2003)). The nanoparticles used in this document do not function as a luminescent material because the surface thereof is not coated with an appropriate surfactant both before and after heating. In contrast, the heating of the present specification plays a role in improving the performance of luminescent material compared to conventional ones.

### II. Luminescent Material Application

The luminescent material of the present invention has high PL efficiency, narrow PL spectrum width, and high chemical resistance. Accordingly, by attaching various antibodies to the surface of the transparent layer, the luminescent material of the present invention can be used as a bio-related fluorescent material (fluorescent marker etc.) for detecting various antigens.

It is also possible to form a glass bead (glass sphere) with a diameter of about 20 nm to about 2 μm that comprises at least two glass-coated semiconductor nanoparticles of the present invention, according to the methods described in Patent Documents 3 and 4. This makes it possible to increase the PL efficiency by introducing a great number of semiconductor nanoparticles of the same emission colors, or to emit light of various colors by mixing semiconductor nanoparticles of different emission colors. By attaching antibodies to the surface of the glass bead, the glass bead can serve as a fluorescent marker that is capable of detecting several antigens in a specimen at high sensitivity.

There are other applications such as displays (display elements) or lighting devices. In order to prevent the deterioration of semiconductor nanoparticles or gap of emission color tones, it is desirable to lower temperatures as much as possible; for example, temperatures of 50° C. or lower are preferable and, if possible, temperatures of 40° C. or lower are more preferable. In order to achieve the above, it is preferable to have a cooling device, heat dissipation material, or the like. Examples of cooling devices include powerful cooling fans, water-cooling devices, Peltier devices, and the like, while examples of heat dissipation materials include metals and ceramics.

### EXAMPLES

Hereunder, the present invention is described in more detail with reference to Examples. However, the present invention is not limited to the Examples.

Evaluation of PL efficiency

The PL efficiency was measured in accordance with the method described above in the “MEANS FOR SOLVING THE PROBLEMS”, at an excitation wavelength of 365 nm. A procedure effective for an easier measurement with fewer errors comprises preliminarily calculating relationships between the absorbance and PL intensity of, at excitation wavelengths, a 0.1 N sulfuric acid solution of quinine at various concentrations; and creating a graph. The details of this procedure are described in the document (Murase et al., Journal of Luminescence, 2008, doi:10.1016/j.jlumin.2008.05.016, posted on Jun. 4, 2007).

### Example 1

Cadmium telluride nanoparticles emitting green light were subjected to a surface treatment to obtain glass-coated nanoparticles emitting yellow to red light, as described below.

Water-dispersible cadmium telluride nanoparticles emitting green light were manufactured in accordance with an existing method (Li, Murase, Chemistry Letters, vol. 34, p. 92, (2005)). More specifically, cadmium perchlorate (hexahydrate, 1.095 g) was dissolved in 200 ml of water. To this, TGA as a surfactant was added in an amount of 1.25 times the mol of cadmium perchlorate. To the result, 1 N aqueous solution of sodium hydroxide was added to adjust the pH to 11.4. After degassing for 30 minutes, hydrogen telluride gas was introduced in an inert atmosphere while stirring vigorously. After stirring for another 10 minutes, a condenser was attached for refluxing at about 100° C. Cadmium telluride particles grew by refluxing, and in about 20 minutes, an aqueous solution containing dispersed nanoparticles emitting green light (2.6 nm in diameter) was obtained.

The precipitate was removed from the obtained aqueous solution, after which 2 ml of the resulting aqueous solution was collected. To this, 2 ml of pure water (Millipore, Milli-Q synthesis grade) and 0.15 ml of tetraethyl orthosilicate (TEOS) were added, followed by the addition of ammonia water (6.25 wt. %). The resulting product was stirred for 3 hours to thereby yield glass-coated nanoparticles.

Thereafter, the glass-coated nanoparticles were measured in size by the TEM observation and dynamic light-scattering method. The results reveal that the size increased to 3.5 nm following the above procedure. In consideration of the particle diameter of semiconductor nanoparticles being about 2.6 nm, it was confirmed that a glass layer with a thickness of about 0.5 nm was formed on the surface of the semiconductor nanoparticles.

The solution was introduced into a three-necked flask, and 6 ml of pure water was added thereto, which was then heated with a mantle heater under stirring, and refluxed for 2 hours in total (about 100° C.). It was observed that the emission color shifted from green to yellow to red with the increase of the refluxing time. During the refluxing, a small amount of sample was collected from the solution, and the absorption spectrum and the PL spectrum were measured using an absorption spectrophotometer (U-4000, Hitachi, Ltd.) and a spectrophotofluorometer (F-4500, Hitachi, Ltd.). FIG. 3 shows the results. The band gap energy can be estimated with reference to the wavelength of the first absorption peak. Specifically, the peak of the first nanoparticles emitting green light (the absorption spectrum of (a) in FIG. 3) is near 515 nm, and therefore, the band gap energy is estimated as 2.41 eV. Further, only the glass covering the nanoparticles was collected, and the absorption was measured. The results reveal that the absorption at the short wavelength side was gradually increased at around 220 nm, and therefore, the band gap energy then is 5.6 eV or more. It is also confirmed that the absorption near the wavelength of 370 nm is increased with the increase of the refluxing time. This is presumably attributable to the cluster formation.

In view of the above results, the emission wavelength dependency of the PL efficiency and emission-spectrum width (FWHM) was plotted as shown in FIG. 4. The PL efficiency of the green PL (wavelength: 552 nm) was about 30%; however, when the emission wavelength thereof was shifted to the red side by about 65 nm with the increase of refluxing time, the PL efficiency increased to 77%. In other words, the PL efficiency relatively increased by 250% or more. The spectrum width (FWHM) was about 50 nm at the beginning, and decreased to 41 nm with the increase of refluxing time. In other words, the FWHM was narrowed by about 18%. Further, the glass-coated nanoparticles were measured in size by TEM observation and dynamic light-scattering method. The results reveal that the size increased to about 5 nm after a 30-minute reflux, and to about 6 nm after a 2-hour reflux. This reveals that the glass layer became thicker by refluxing.

The solution was collected during the refluxing to perform an X-ray small angle scattering measurement. A Nano-Viewer manufactured by Rigaku Corporation was used, and the incident X-ray wavelength was adjusted to 0.154 nm. FIG. 5 shows the results. In the figure, the theoretical curve, the thin solid line, represents CdTe nanoparticles with a diameter of 2.6 nm that are covered with a glass layer, forming particles with an average particle diameter of about 5 nm. At angles represented by 2θ of 0.4° or less, the sample contains a trivial amount of an aggregation component; therefore, the scattering intensity value thereof is greater than that of the theoretical curve. At angles of 3° or more, the existence of another scattering component in the sample is recognized. At the region of the angles of 3° or more, the scattering component is derived from particles with a size of about 1 nm; this clearly implies the existence of clusters with this size. In view of the manufacture conditions etc., the concentration of the clusters in the glass layer was estimated as about 0.3 mol/liter.

The solution of manufactured glass-coated nanoparticles and the solution of the nanoparticles used as a starting material were each prepared to measure the fluorescence decay times using a FluoroCube manufactured by HORIBA, Ltd. The results showed that, with respect to the nanoparticles emitting green PL used as a starting material, the fluorescence decay times of the main lifetime components were 20 ns and 50 ns; with respect to the nanoparticles emitting red PL, the fluorescence decay times of the main lifetime components were also 20 ns and 50 ns. These results suggest that the surface of the glass-coated nanoparticles manufactured in accordance with the method of the present invention was well-maintained without a significant change in the emission lifetime. When the surface is deteriorated, the PL efficiency will be decreased, and at the same time, wide varieties (50% or more in the relative comparison) will likely be seen in the main components occupying 70% of the emission lifetimes.

Sodium hydroxide was dissolved in a dispersion of the above-mentioned glass-coated nanoparticles to adjust the pH to about 13; thereby, the glass that was coated on the surface was dissolved. Consequently, the spectrum returned to that of the first nanoparticles emitting green PL, as shown in FIG. 6. This experiment clarifies that the emission wavelength shifted by refluxing to the red side was not due to the nanoparticle growth.

Further, the resulting solution containing the dispersed glass-coated nanoparticles was filtrated to remove water, which is a solvent, and free small molecules and ions, such as surfactants, ammonia, cadmium ions, and the like; and concentrated from 50 ml to 2 ml. Thereafter, water was added to a total volume of 50 ml, and concentrated again under the same conditions as above. Subsequently, water was added thereto and stirred, and the solution was then filtrated through a filter with a pore size of 0.2 micron to remove aggregated glass-coated nanoparticles, etc. Further, the resulting product was refluxed for 2 hours to obtain nanoparticles coated with a harder glass layer. The obtained product was then poured into a phosphate buffered saline (PBS buffer solution) having the same osmotic pressure as that of a biological body. Even 20 days thereafter, the emission spectrum did not change.

In contrast, with respect to the nanoparticles before grass coating, the PL efficiency decreased by half in one day within the same solution. Accordingly, the glass-coated nanoparticles were confirmed to exhibit higher durability even in the solution. This is very important when applying the glass-coated nanoparticles as a fluorescent probe of a biological body.

### Example 2

In the above procedure, the dispersion of the nanoparticles from which precipitates were removed was not directly used, and the nanoparticles were once precipitated by adding dropwise an alcohol, which was a poor solvent, to the dispersion. The obtained precipitate was recovered by centrifugal separation, and dissolved in water containing a dispersed TGA as a surfactant and cadmium perchlorate. The pH of the solution was adjusted to about 10.5. Then, TEOS and ammonia were added thereto, and stirred in the same manner as in Example 1.

Pure water was further added to the resulting product, which was stirred and refluxed. The concentration of the nanoparticles at the time of refluxing was about 5.8×10⁻⁶ mol/liter; the concentration of TGA not adhering to the nanoparticles (concentration of free TGA in the solution) was about 2×10⁻³ mol/liter; and the concentration of the cadmium not incorporated into the nanoparticles (concentration of free cadmium in the solution) was about 4×10⁻⁴ mol/liter. When the molar concentration of the nanoparticles at this time is normalized as 1, the equivalent concentration of free cadmium is calculated as 69, and the equivalent concentration of free TGA is calculated as 345; accordingly, the equivalent concentration ratio of the free TGA to the free cadmium can be calculated as 5:1.

With the increase of the refluxing time, the same spectral change as in Example 1 was observed.

### Example 3

Cadmium telluride nanoparticles emitting red PL were subjected to a surface treatment, and the glass-coated nanoparticles whose PL was further shifted to the red side (longer-wavelength side) were obtained as below.

In Example 1, cadmium telluride nanoparticles emitting green PL, which were collected after a 20-minute reflux, were used. However, the refluxing time was extended to about 120 hours to obtain nanoparticles emitting red PL, in accordance with the aforementioned existing method (Murase et al., Journal of Luminescence, 2008, doi:10.1016/j.jlumin.2008.05.016, posted on Jun. 4, 2007). The diameter of the nanoparticles at this time was about 4.0 nm. The PL efficiency was 70%, and the PL spectrum width (FWHM) was 53 nm.

Subsequently, glass coating and refluxing were performed in the same manner as in Example 1. As a result, as shown in FIG. 7, it was confirmed that the emission wavelength further shifted to the red side. The PL efficiency at this time was 84%, and the PL spectrum width (FWHM) was 47.4 nm. Specifically, the FWHM became narrower than the above by 11%.

However, because the original particle diameter was large, even when the electron distribution region was increased as a result of the surface treatment of the present invention, the emission wavelength did not shift to the red side as much as the nanoparticles emitting green PL shifted. Moreover, the absorption peak derived from clusters was observed near 370 nm.

### Example 4

As described below, with respect to zinc selenide nanoparticles emitting blue PL, the emission wavelength shifted to the red side similarly to the above.

Zinc selenide nanoparticles were manufactured in accordance with an existing method (Li et al., Colloids and Surfaces A, vol. 294, p. 33, (2007)). Thereafter, glass coating and refluxing were performed in the same manner as in Examples 1 and 2. Consequently, as shown in FIG. 8, remarkable increases in the PL intensity and shifting of the emission wavelength to the red side were observed. The results shown in FIGS. 7 and 8 reveal that the surface treatment method of the present invention is generic.

### BRIEF DESCRIPTION OF THE DRAWINGS

FIG. 1 schematically shows the size of semiconductor nanoparticles and the band gap energy. The atomic number of nanoparticles falls within the range of about the hundreds to about the thousands, and the size thereof falls within the range of about 2 to 10 nm.

FIG. 2 is a graph showing the intensities of the PL emitted from the semiconductor nanoparticles (wavelength: λ₁) that had been subjected to a known surface treatment, and the PL emitted from the semiconductor nanoparticles (wavelength: λ₂) that had been subjected to a novel surface treatment, with a proviso of Wavelength λ₂>Wavelength λ₁. The figure also illustrates each of the nanoparticles by showing the semiconductor nanoparticle (core), transparent layer (shell) and the inside thereof.

FIG. 3 is a graph showing the absorption spectrum change and the PL spectrum change made by reflux with respect to the glass-coated cadmium telluride nanoparticles. The (a)s represent the spectra of the original nanoparticles emitting green PL; the (b)s represent the spectra after a 0.5-hour reflux; the (c)s represent the spectra after a 1.5-hour reflux; and the (d)s represents the spectra after a 3.0-hour reflux.

FIG. 4 is a graph showing the changes in the PL peak wavelength, the PL efficiency and the PL-spectrum width (FWHM), along with the increase of the refluxing time of the glass-coated nanoparticles.

FIG. 5 is a graph showing the results of the X-ray small angle scattering measurement (solid line); the theoretical curve (dashed line) represents only hypothetical large glass-coated nanoparticles having a diameter as large as about 5 nm. In the solid line at the region wherein the angle is 3° or more, scattering can be observed due to the existence of small clusters having a diameter as small as 1 nm.

FIG. 6 is a graph showing the emission-spectrum change made by removal of the glass layer using alkaline solution. (a) represents the colloidal solution of the cadmium telluride nanoparticles emitting green PL; (b) represents that of the glass-coated nanoparticles after reflux; and (c) is the PL spectrum of nanoparticles after removing the glass layer using alkaline solution.

FIG. 7 is a graph showing the PL-spectrum change made by reflux of the cadmium telluride nanoparticles emitting red PL before and after the nanoparticles were coated with a glass. The (a)s represent the absorption spectrum and the PL spectrum of the nanoparticles before glass coating; and the (b)s represent the absorption spectrum and the PL spectrum of the nanoparticles that were refluxed for 1.5 hours after the nanoparticles were coated with a glass.

FIG. 8 is a graph showing the changes in the absorption spectrum and the PL spectrum made by reflux of the zinc selenide nanoparticles emitting blue PL before and after the nanoparticles were coated with a glass. The (a)s represent the absorption spectrum and the PL spectrum of the ZnSe nanoparticles immediately after being produced according to a solution method; the PL spectrum of (a) is weak, and therefore, the spectrum value is multiplied 300 times. The (b)s represent the absorption spectrum and the PL spectrum of the nanoparticles refluxed for 1.5 hours after the nanoparticles were coated with a glass.

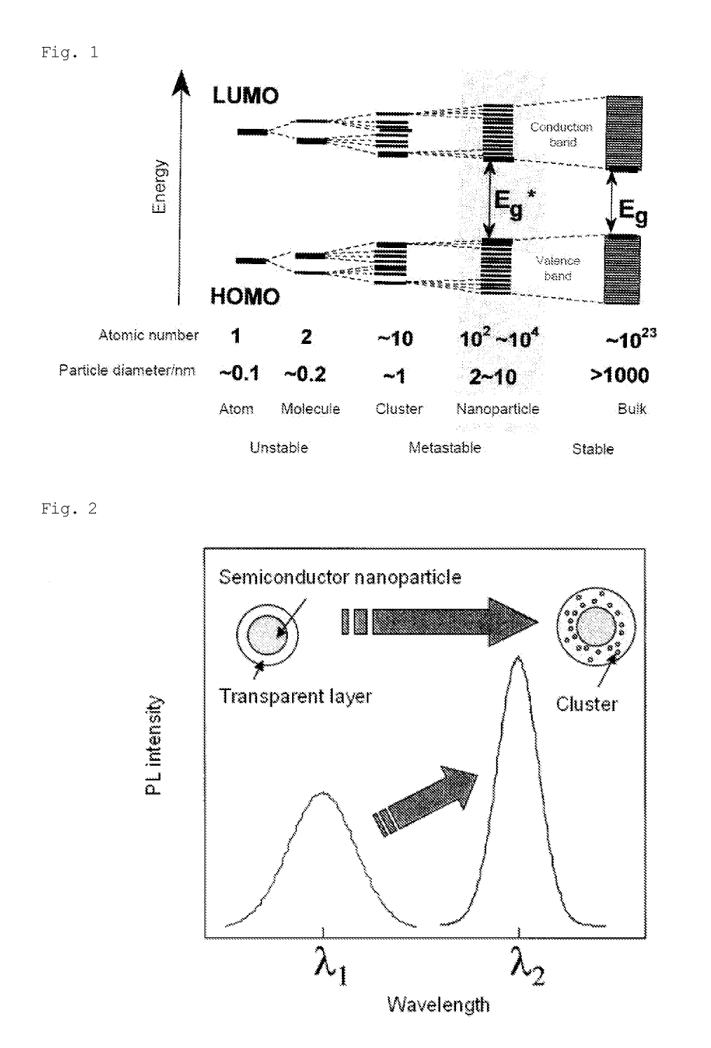

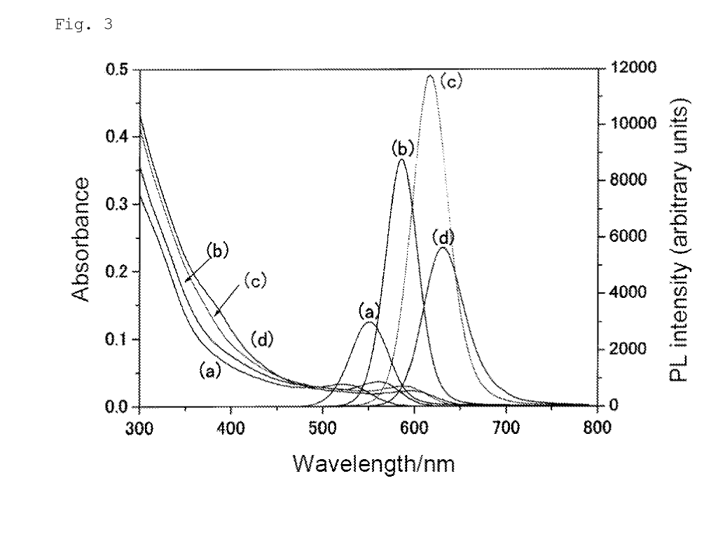

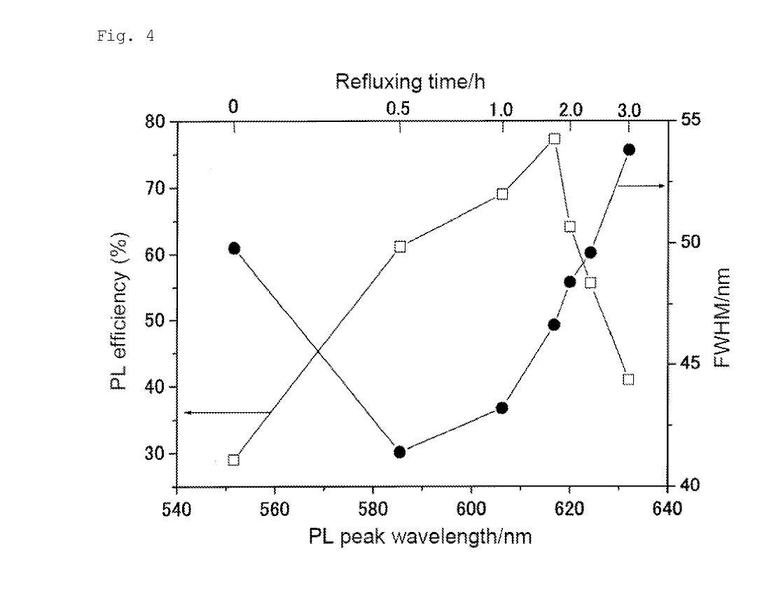

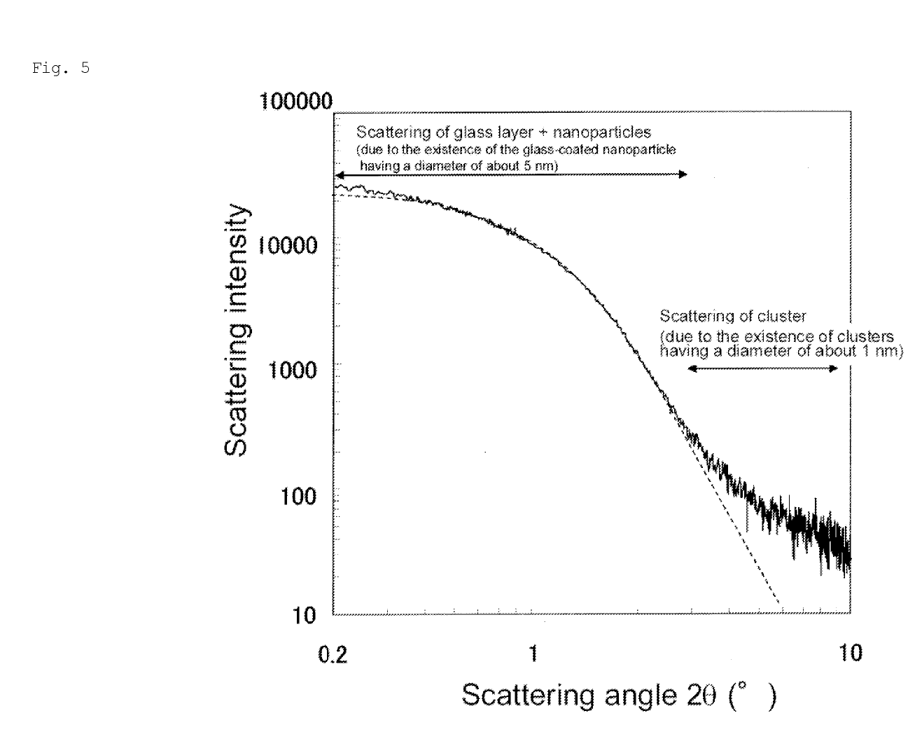

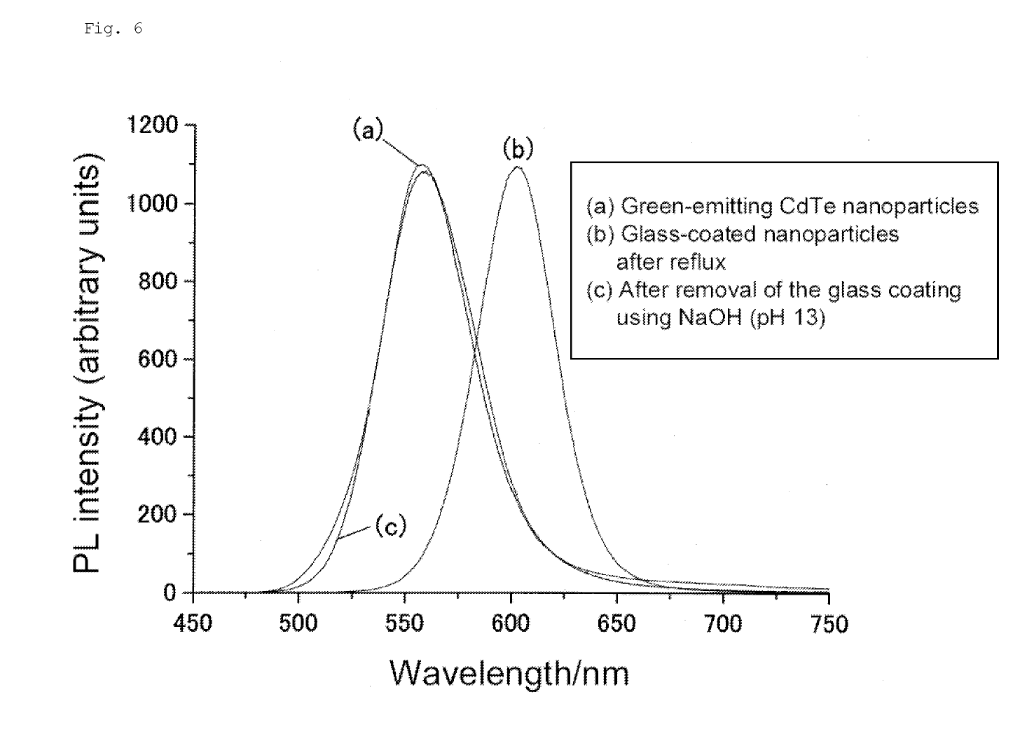

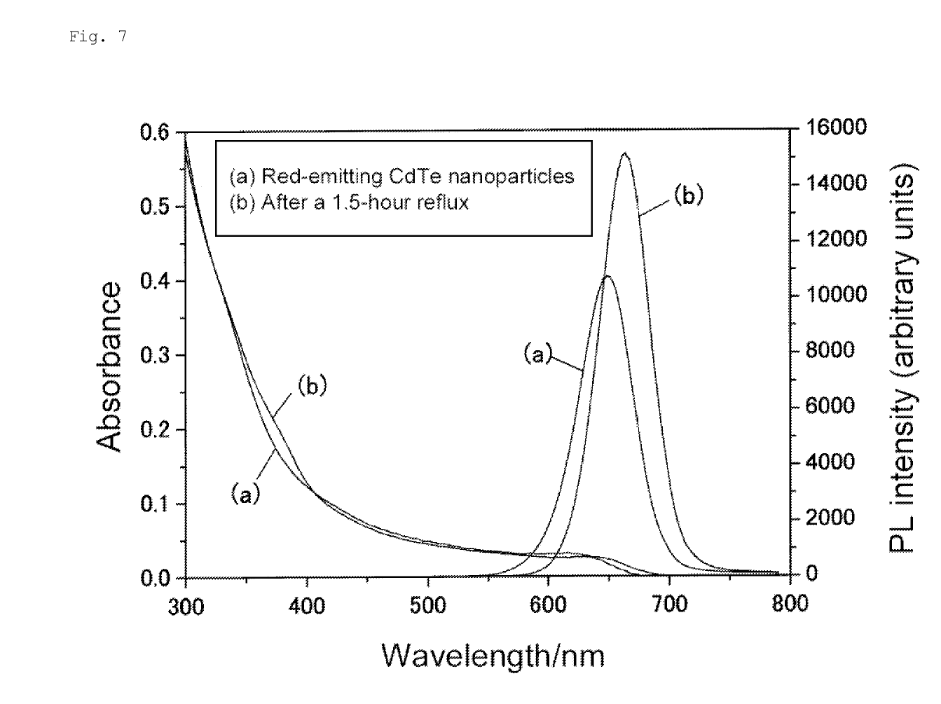

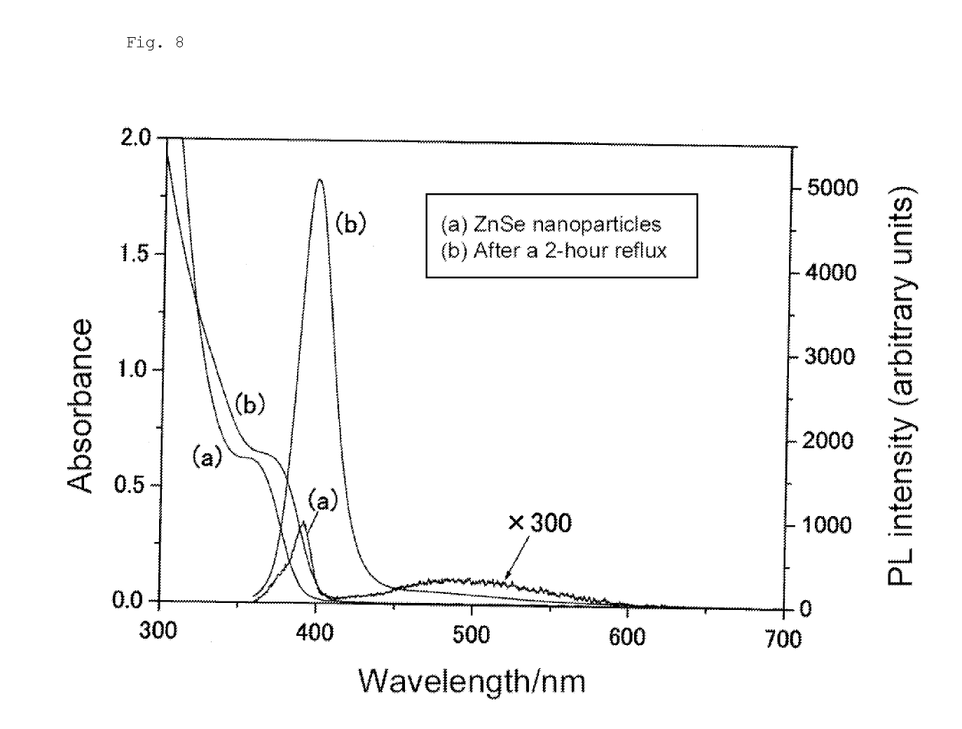

1. A luminescent material comprising semiconductor nanoparticles having a mean particle size of 2 to 12 nm and a band gap of 3.8 eV or less, each of the semiconductor nanoparticles being coated with a silicon-containing layer, the semiconductor nanoparticles in the luminescent material having a peak emission wavelength 20 nm or more towards the longer-wavelength side than the peak emission wavelength of the semiconductor nanoparticles alone.

2. The luminescent material according to claim 1, wherein the silicon-containing layer comprises clusters at a concentration of 0.01 mol/L or more, the clusters having a diameter of 0.5 to 2 nm and containing component(s) used for forming the semiconductor nanoparticles.

3. The luminescent material according to claim 1, wherein the semiconductor nanoparticles in the luminescent material have an emission spectrum width (FWHM) at least 10% narrower than the emission spectrum width (FWHM) of the semiconductor nanoparticles alone.

4. The luminescent material according to claim 1, wherein the relation between the PL efficiency (η₁) from the semiconductor nanoparticles in the luminescent material and the PL efficiency (η₂) from the semiconductor nanoparticles alone is η₁≧1.3×η₂.

5. The luminescent material according to claim 1, wherein the silicon-containing layer is a layer obtained by forming a coating layer on the surface of the semiconductor nanoparticles by a sol-gel method using a silicon alkoxide, and heating the obtained semiconductor nanoparticle coated with the coating layer.

6. The luminescent material according to claim 1, wherein the silicon-containing layer is a layer obtained by adding a silicon alokoxide to a semiconductor nanoparticle dispersion, forming a coating layer on the surface of the semiconductor nanoparticles by a sol-gel method, and heating the obtained semiconductor nanoparticle coated with the coating layer.

7. The luminescent material according to any one of claims 1 to 6, wherein the PL efficiency is 20% or more.

8. The luminescent material according to claim 1, wherein the PL efficiency is 70% or more.

9. The luminescent material according to claim 1, wherein the semiconductor nanoparticles belong to Group II-VI semiconductors.

10. The luminescent material according to claim 1, wherein the semiconductor nanoparticles belong to Group III-V semiconductors.

11. The luminescent material according to claim 1, wherein the semiconductor nanoparticles comprise at least one member selected from the group consisting of zinc, cadmium, mercury, sulfur, selenium, tellurium, aluminium, gallium, indium, phosphorus, arsenic, antimony, and lead.

12. A glass sphere having a diameter of 20 nm to 2 μm, comprising at least two luminescent materials according to claim 1.

13. A light-emitting device comprising a luminescent material according to claim 1.

14. A fluorescent material for biotechnology applications comprising a luminescent material according to claim 1.

15. A method for producing the luminescent material according to claim 1, the method comprising the steps of:
(1) forming a coating layer on the semiconductor nanoparticles having a mean particle size of 2 to 12 nm, and a band gap of 3.8 eV or less, by a sol-gel method using a silicon alkoxide; and
(2) heating the semiconductor nanoparticles on which the coating layer has been formed.
